(19) United States
(12) Patent Application Publication
(10) Pub. No.: US 2009/0089166 A1
(43) Pub. Date: Apr. 2, 2009

(54) Providing dynamic content to users

(76) Inventor: Aki P. Happonen, Kiiminki (FI)

Correspondence Address: Hollingsworth & Funk, LLC, 8009 34th Avenue South, Suite 125, Minneapolis, MN, 54425, US

(21) Appl. No.: 11/906,255

(22) Filed: Oct. 1, 2007

(51) Int. Cl. G06Q 30/00

(52) U.S. Cl. 705/14

(57) ABSTRACT

Systems, apparatuses and methods for providing dynamic advertising and other content to requesting users via mobile web servers. Advertisement content is acquired at a mobile device based on a context of the mobile device, such as it's location relative to a source of the advertisement content. The mobile device hosts a network-accessible server, and at least the acquired advertisement content is provided by way of the network-accessible server upon access to the network-accessible server by a requesting device(s).

### FIELD OF THE INVENTION

This invention relates in general to mobile communications, and more particularly to systems, methods and apparatuses for providing dynamic advertising and other content to requesting users via mobile web servers.

### BACKGROUND OF THE INVENTION

Technological advances in communication infrastructures and protocols have turned standard computing devices into valuable communication tools. Computers communicate with each other, and with other electronic devices, over networks ranging from Local Area Networks (LANs) to wide reaching Global Area Networks (GANs) such as the Internet. Other electronic devices have experienced similar transformations, such as mobile phones, Personal Digital Assistants (PDAs), and the like. Today, these wireless devices are being used for a variety of different types of communication. For example, current mobile phone and PDA technologies are powerful communication tools capable of communicating voice, text or other data, documents, images, video and other multimedia content (generally referred to herein as communications).

Today's technologies often involve network servers that communicate requested information to requesting computers and wireless devices. Thus, a fixed server operable via a network can receive requests from these consuming end user devices, and provide content by way of the Internet or other network. These fixed servers must initiate and manage the creation or acquisition of the content to be provided. As a result the ultimate consumers of the information, i.e., the device users requesting the information from the server, in many cases must know of or otherwise locate the particular server to obtain the requested information or related information such as entity advertisements. Further, the entities providing the fixed servers that serve as the source of the advertising content may have difficulty reaching end users, and especially those end users that may have a link with other users who find the entities products or services of interest.

Accordingly, there is a need for new approaches for facilitating content communication via networks. The present invention fulfills these and other needs, and offers advantages over prior art approaches.

### SUMMARY OF THE INVENTION

To overcome limitations in the prior art described above, and to overcome other limitations that will become apparent upon reading and understanding the present specification, the present invention discloses systems, apparatuses and methods for providing dynamic advertising and other content to requesting users via mobile web servers.

In accordance with an exemplary method of the invention, advertisement content is acquired at a mobile device based on a context of the mobile device. The mobile device hosts a network-accessible server, and at least the acquired advertisement content is provided by way of the network-accessible server upon access to the network-accessible server by a requesting device(s).

According to other embodiments of such a method, acquiring advertisement content based on the mobile device context involves receiving the advertisement content based on the physical location of the mobile device relative to an entity that sources the advertisement content. In a more particular embodiment, determining the physical location of the mobile device relative to the entity that sources the advertising content is accomplished using a global positioning system.

Another embodiment of such a method involves acquiring the advertisement content by receiving the advertisement content based on a physical location of the mobile device relative to a communications agent of the entity associated with the advertisement content. In a more particular embodiment the communications agent represents or includes a proximity network access point, such that acquiring the advertisement content involves downloading the advertisement content associated with the entity via the proximity network access point. In another particular embodiment the communications agent is represented by or otherwise includes a kiosk, such that acquiring the advertisement content involves downloading the advertisement content associated with the entity from the kiosk.

An embodiment of such a method may further include the mobile device moving from a first location to a second location. In such a case, acquiring advertisement content at the mobile device involves acquiring first advertisement content when the mobile device is at a first location, and acquiring second advertisement content when the mobile device at a second location. Providing the acquired advertisement content then involves providing at least the first advertisement content when the mobile device is at the first location, and providing the second advertisement content when the mobile device is at the second location.

One embodiment of such a method involves the mobile device accessing a network site. In this case, acquiring advertisement content based on a context of the mobile device may involve receiving the advertisement content at the mobile device as a result of the accessing of the network site. Similarly, an embodiment may entail the mobile device browsing to an external web site to access first content, wherein acquiring advertisement content based on a context of the mobile device involves automatically receiving the advertisement content at the mobile device as a result of browsing for the first content.

Yet another embodiment of the representative method involves hosting the network-accessible server by configuring a web page(s) to present to the requesting device a display area corresponding to first web content associated with network-accessible server, and to present to the requesting device at least one additional display area corresponding to the advertisement content.

Compensation, which includes any type of received benefit to the mobile device user, may be associated with the mobile user's hosting of the advertising or other content. In one embodiment, an agreement is established between the user of the hosting mobile device and an entity that sources the advertisement content. In such case, acquiring and providing the advertisement content via the network-accessible site on the mobile device may be, but does not have to be, dependent on the prior establishment of the agreement.

The mobile web server enables the mobile device to host the advertising (or other) content alone, or in addition to other web content otherwise intended to be hosted via the mobile web server. For example, in one embodiment of the method described above, web content may be hosted via the mobile device's network-accessible server—e.g., via its mobile web server. In such a case, providing at least the received advertisement content may involve providing either or both of the web content and the received advertisement content to the requesting device via the network-accessible server.

In accordance with another embodiment of the invention, an apparatus is provided that includes at least a location services module, a receiver, and a mobile web server. In one embodiment, the location services module may be configured to facilitate determination of a location of the apparatus relative to some entity. The receiver is configured to receive advertisement content when the determined location of the apparatus relative to the entity enables receipt of the advertising content from the entity. The mobile web server module is configured to update web content with at least some of the advertisement content, and to provide the updated web content to requesting devices in response to their access to the mobile web server module.

According to other embodiments, such an apparatus may further include a browsing agent configured to access network sites, where the receiver is configured to receive at least some of the advertisement content as a result of the browsing agent accessing the respective one or more network sites. Another example involves a browsing agent that is configured to access an external web site to access first content, where the receiver receives at least some of the advertisement content as a result of the browsing agent accessing the first content at the external web site.

In one embodiment the receiver is configured to acquire first advertising content when the location services module determines that the apparatus is located at a first location, and to acquire second advertising content when the location services module determines that the apparatus is located at a second location. This similarly applies to third locations, fourth locations, etc. One embodiment further involves a database configured to store the advertising content received from at least the first and second locations, where the mobile web server module is configured to update web content with at least the first and second advertising content irrespective of the location of the apparatus when the updated web content is provided to the requesting devices. In other embodiments the mobile web server may be configured to provide the updated content to the requesting devices at a time when the apparatus is located at the location where the advertisement content was received.

According to another embodiment of the invention, a system is provided that includes at least a mobile device, and an entity having a communications agent. The entity's communications agent facilitates communication of advertisement content. The mobile device includes at least a location services module, a receiver and a mobile web server. The location services module is configured to facilitate determination of a location of the apparatus relative to the entity. The receiver is configured to receive the advertisement content via the communications agent when the determined location of the mobile device is within a communication range of the communications agent. The mobile web server is configured to update web content with at least some of the received advertisement content, and to make the updated web content available to requesting devices in response to their access to the mobile web server.

According to more particular embodiments, such a system may further include at least one requesting device capable of initiating a request for the updated web content via a network. In one embodiment, the requesting device includes a display module configured to present the updated web content to distinguish the received advertisement content from other web content hosted by the mobile web server.

According to still other particular embodiments of such a system, the entity having the communications agent may be represented by a proximity network access point capable of wirelessly communicating the advertisement content to the receiver of the mobile device. In other embodiments the entity may be represented by stand-alone systems that locally store or otherwise acquire the relevant advertising content, such as in the case of a kiosk. For example, the entity having the communications agent may be represented by a kiosk capable of storing the advertisement content and providing the advertisement content to the receiver of the mobile device by way of wireless and/or wired connections.

In accordance with another embodiment of the invention, computer-readable media may be provided to store instructions that are executable by a processing system for performing a method according to the invention. For example, temporary or permanent storage may store instructions to acquire advertisement content at a device based on a context of the mobile device, host a network-accessible server on the device, and provide at least the acquired advertisement content via the network-accessible server upon access to the network-accessible server by a requesting device.

The above summary of the invention is not intended to describe every embodiment or implementation of the present invention. Rather, attention is directed to the following figures and description which sets forth representative embodiments of the invention.

### BRIEF DESCRIPTION OF THE DRAWINGS

The invention is described in connection with the embodiments illustrated in the following diagrams.

FIG. 1 is a block diagram illustrating an exemplary embodiment of a system for providing advertisements or other content to consuming devices by way of dynamic location-based content collection by the device hosting a mobile web service;

FIGS. 2-4 are flow diagrams generally illustrating representative embodiments of methods for providing advertisements or other content via a mobile web server in accordance with the present invention;

FIG. 5 illustrates a representative embodiment of the content consumer's presentation screen that can be viewed while browsing to or otherwise accessing the mobile web server and associated dynamic advertisements;

FIGS. 6A-6D depict various representative embodiments in which such advertisement content may be received at the mobile web server; and

FIG. 7 illustrates an exemplary embodiment of a mobile device computing system capable of carrying out operations in accordance with the invention.

### DETAILED DESCRIPTION OF EMBODIMENTS OF THE INVENTION

In the following description of the exemplary embodiment, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention provides systems, apparatuses and methods for providing dynamic content to users via mobile web servers. A particular embodiment involves a mobile web server obtaining content such as advertisements based on the changing locations of the mobile device hosting the mobile web server, and hosting the advertisements via the mobile web server for viewing or other consumption by users who access the mobile web server. These advertisements (e.g., coupons, event schedules, product/price notifications or other content) can be presented as, for example, dynamic banners in the viewing area of the devices of the users accessing the mobile web server.

The content (e.g., advertisements) obtained by the mobile web server is obtained based on activity associated with the mobile device hosting the mobile web server. For example, advertisements may be dynamically collected by the mobile web server based on the geographic locations visited by the mobile device hosting the mobile web server. As a more particular example, the mobile device hosting the mobile web server may physically move from geographic location to geographic location, where advertisements or other content available at these geographic locations may be gathered by the mobile device for inclusion into content provided by the mobile web server. In another exemplary embodiment, advertisements may be dynamically collected by the mobile web server based on the electronic/network locations visited by the mobile device hosting the mobile web server. As a more particular example, the web server hosting device user may browse to a network location(s) from which the advertisements or other content is obtained, which can in turn be included into the content provided by the mobile web server.

Using such systems, apparatuses and/or methods, end users who access network content can benefit from the geographic and/or browsing locations of the user of the mobile device hosting the mobile web service. For example, an end user may have a social, business, political, educational or other common feature (or even no common feature) with a mobile user who hosts a mobile web service, whereby that end user can benefit from the geographic and/or electronic movements of that mobile web service by receiving advertisements relating to that common relationship. The end user can thus access a mobile web service and receive information/advertisements from a variety of entities that they might not otherwise be aware of or have access to. This can also benefit the entities to which the mobile web server obtains advertising or other content, as the entities may not otherwise be able to reach those ultimate content consumers directly.

Further, the user hosting the mobile web service may have an opportunity to capitalize on his/her web offering by way of receiving payment or other benefit for hosting the advertisements for the person(s) or entity to which the advertisement pertains. For example, the mobile web server may be moved to a geographic location where advertisements are received and in turn provided via the mobile web server, whereby payment or other benefit may be made to the hosting user of the mobile web server for disseminating such advertisements. In this manner the mobile web service provider brings value from his/her mobility.

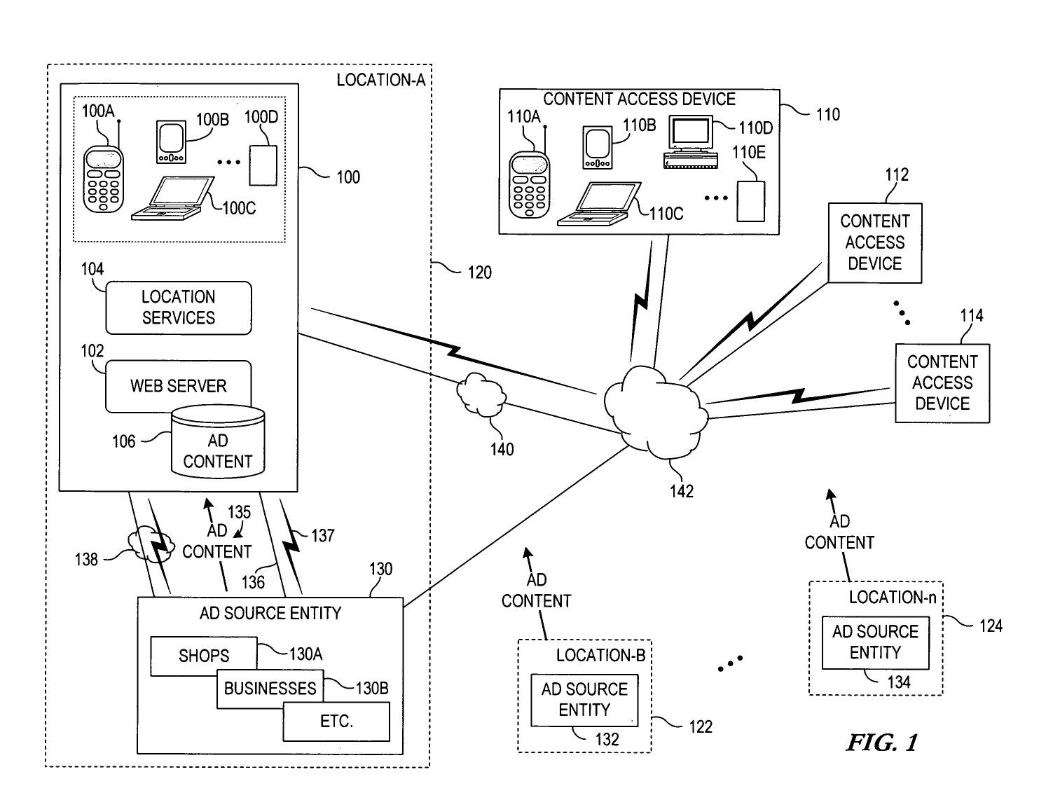

FIG. 1 is a block diagram generally illustrating one embodiment of a system for providing advertisements or other content to consuming devices by way of dynamic location-based advertisement/content collection by the device hosting a mobile web service. A mobile device 100 represents the device that hosts the mobile web server 102, and for purposes of the description of FIG. 1 is referred to as the “hosting mobile device” or simply the “hosting device.” The hosting device 100 may be represented by any device capable of operation while mobile, such as a mobile phone 100A, personal digital assistant 100B, laptop/notebook or other mobile computing device 100C, or other device 100D capable of wireless communication. The hosting device 100 includes a web server module 102, which in one embodiment includes executable software or code that accepts requests from content access devices (e.g., devices 110, 112, 114), such as by way of browser clients affiliated with such devices 110, 112, 114, etc. The content access devices 110, 112, 114 represent any device capable of receiving content from another device(s), such as, for example, a mobile device 110A, personal digital assistant 110B, portable computing device 110C, terminal or desktop/workstation computing device 110D, or other electronic device 110E capable of receiving web or other external data. The web server module 102 responds to such requests with data such as web pages such as, for example, Hypertext Markup Language (HTML) documents that may or may not include linked objects such as images, audio, etc. The hosting device 100 represents a “mobile web server” in that the device 100 hosting the web server is a mobile device capable of wirelessly communicating its web pages or other hosted content at various locations made possible due to its mobility.

In one embodiment the hosting device 100 includes a location services module 104 that enables a geographic location of the device to be identified. The geographic location may be determined in various manners as further described herein. For example, the geographic location of the hosting device 100 may be determined using Global Positioning System (GPS), wherein the location services 104 thus represents a GPS module capable of enabling GPS systems to identify the location of the device housing that GPS module.

Another example of a location services module 104 that involves relative geographic locations is where the location services module 104 represents a Bluetooth client that communicates with a Bluetooth (or analogous) access point or “hotspot” when it is located within a transmission range of the access point/hotspot. Bluetooth, for example, is a computing and telecommunications industry specification that describes how mobile phones and other mobile terminals can interconnect with each other and with home and business phones/computers using a short-range wireless connection. A “hot spot” refers to a location that has a readily accessible wireless network available to multiple people within the hot spot range. A Bluetooth hot spot is thus a location such that when a device equipped with a Bluetooth module is within range of a Bluetooth access point, the user can connect wirelessly to the access point. The access point may be connected to a server to provide, for example, advertisements to the hosting device. The access point may additionally or alternatively facilitate connectivity to a local network and/or the Internet to obtain the advertisements.

The location services module 104 may represent other location identifying capabilities, such as technologies enabling relative locations to be determined. For example, the location services module 104 may represent a wireless local area network client that can wirelessly communicate with a wireless access point when within a transmission range of the wireless access point. An example of such a system is a wireless local area network (WLAN) system such as IEEE 802.11x (where “x” represents a, b, g, etc.). Other “relative” geographic locations may be provided by way of infrared (IR) systems, where the hosting device 100 location is relative to an IR source. These and/or other wireless technologies may be represented by the location services module 104.

The location of the hosting device 100 may also be determined by its location in a cellular infrastructure, which can be determined in view of the location tracking performed in connection with the cellular infrastructure. Particularly, mobile devices can be tracked to particular locations in cellular networks. For example, a Global System for Mobile communications (GSM) network (as well as other cellular networks) includes a number of identifiers used to identify the various network constituents. Mobile terminals are generally associated with an equipment identifier, and the user of the mobile terminal is generally associated with a subscriber identifier (such as that provided by a Subscriber Identity Module (SIM)) as well as with an identifier such as a telephone number. In addition, several other identifiers may be defined for managing subscriber mobility and addressing other network elements. Other identifiers include a cell identifier (cell-ID) and the Base Transceiver Station Identity Code (BSIC). To understand these identifiers, it is noted that cellular networks such as GSM networks include various geographic areas, including cells, Location Areas (LAs), MSC/VLR service areas, and Public Land Mobile Network (PLMN) areas. A cell is the area generally corresponding to a Base Station (BS) radio coverage area, and is identified via the cell-ID. The LA represents a group of cells, and corresponds to the area in which subscribers are paged, where paging refers to the act of broadcasting over the setup channel in order to locate a mobile terminal. Each LA is assigned a location area identity (LAI) number. Within a particular LA, the individual cells are uniquely identified with a cell-ID. Together with the LAI, cells can be uniquely defined on an international level. Using such identifiers, cellular users can be tracked to various degrees of location specificity. Accordingly, the location of the mobile device 100 can be determined to varying degrees of specificity using any one or more of the identifiers associated with that mobile device 100 in the network. In such an embodiment, the location services module 104 represents the identifiers used by the network to track the location of the mobile device 100.

FIG. 1 illustrates numerous representative locations, labeled location-A 120, location-B 122 through location-n 124. In accordance with one embodiment of the invention, the mobile device 100, and consequently the mobile web server 102, moves from location to location as a result of user mobility. At any one or more of these locations 120, 122, 124, there may be a content source(s) that ultimately provides content to the mobile device for ultimate hosting via its web server 102. For example, assuming the content involves advertisements, each of the depicted locations 120, 122, 124 in FIG. 1 respectively includes one or more advertisement (ad) source entities 130, 132, 134. These add source entities may be any source of advertisements or other content, such as, for example, shops 130A or other businesses 130B, etc.

When the mobile device 100 is in location-A 120 corresponding to ad source entity 130, the mobile device 100 can then obtain the ad content 135. This ad content 135 may be provided to the content access devices 110, 112, 114 via the web server 102 via one or more networks 140, 142. The ad content 135 may be obtained by the mobile device 100 in any known manner. For example, the ad content 135 may be received via direct wired connections 136, such as a Universal Serial Bus (USB), firewire (IEEE 1394), etc. The ad content 136 may be received via direct wireless connections 137, such as wireless USB, peer-to-peer networking, IR, etc. The ad content 135 may also be received via wired and/or wireless networks 138, such as via WLAN, Wibree/Bluetooth access points, cellular networks, local area networks, the Internet (e.g., network 142), etc.

The received ad content 135 is in turn provided to content access devices 110, 112, 114, etc. via the web server 102. The ad content may immediately be updated on the web server 102, or alternatively may be stored in an ad content database 106. If stored in a local database 106, the received ad content may be provided intermittently, periodically, randomly or otherwise with other stored advertisements to the content access devices. Thus, a content access device 110, 112, 114 accesses the mobile web server 102 by, for example, directing its browser or other program to an address (including actual address, indirect address, alias, etc.) of the mobile web server 102, the content access device 110, 112, 114 can receive at least one or more of the advertisements associated with the location-based ad content 135 received at a particular location 120, 122, 124, etc. The end user using the content access device 110, 112, 114 typically (but not necessarily) also receives other web content provided via the mobile web server 102.

A system as described in connection with FIG. 1 can therefore provide, among other things, advertisements via mobile web pages where the advertisements reflect the physical routes taken by the user of the mobile device hosting the mobile web service. In one embodiment the hosting device 100 includes some location capability 104 and a web server 106. The hosted web pages/documents can then serve physical route-based advertising to visitors of those web pages/documents. For example, in operation, the user of the hosting device 100 may visit department stores 130, 132 (e.g., ad source entities 130, 132) at their respective locations 120, 122. The user may have an agreement with those stores to advertise in his/her mobile web server 102. The hosting device's mobile web server 102 can automatically update banners or other areas on the hosted web site with store-specific advertisements, events, coupons, etc. End users of the content access devices 110, 112, 114 therefore receive the dynamic, location-based ad banners. The user of the hosting device 100 may also browse via the hosting device 100 to obtain advertisements, check event schedules and/or perform other activity that can be downloaded to the hosting device 100 for inclusion on the web pages/documents. When the hosting device 100 moves to another location 124, new ads can then be received and the end users of the content access devices 110, 112, 114 perceive the new ads.

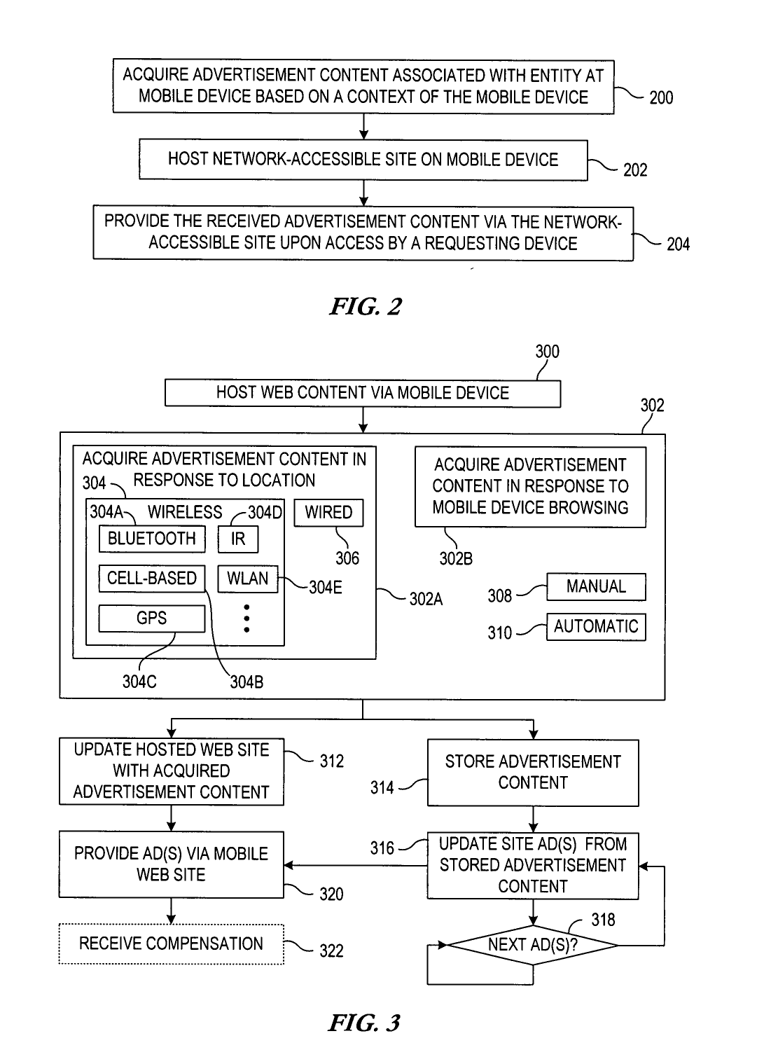

FIG. 2 is a flow diagram generally illustrating a representative embodiment of a method for providing advertisements or other content via a mobile web server in accordance with the present invention. The advertisement content associated with an entity is acquired 200 at the mobile device based on a context of the mobile device. In one embodiment this context is the physical location of the hosting mobile device where the advertisement information can be acquired 200. In another embodiment this context is the electronic location in which the user of the hosting mobile device is accessing in order to download or otherwise acquire 200 the advertisement content. A network-accessible site is hosted 202 on the mobile device, such as a web site accessible by end users by way of the Internet and/or other network. The received advertisement content is provided 204 via the network-accessible site upon access by a requesting device, such as the content access devices 110, 112, 114 described in connection with FIG. 1.

FIG. 3 is a flow diagram generally illustrating a representative embodiment of a method for providing advertisements via a mobile web server in accordance with the present invention. In the illustrated embodiment a mobile device hosts 300 web content. Advertisement content is acquired 302, such as by acquiring 302A the ad content in response to the physical location of the hosting mobile device, or in response to browsing 302B or other manner of retrieving electronic information at the mobile device. As previously described, acquiring the ad content in response to a physical location may be accomplished using any known wireless 304 or wired 306 location capabilities. Wireless 304 location capabilities include, for example, Bluetooth 304A, cell-based 304B, GPS 304C, infrared 304D, WLAN 304E, etc. The receipt of the ad content may be manual 308 in that one or more user inputs are involved, or the receipt of the ad content may be automatic 310 in that the ad content is automatically provided to the hosting mobile device. For example, the ad content may be automatically provided to the hosting mobile device in response to the user being located at a particular location or browsing to a particular web site. The receipt of the content may also involve some combination of manual 308 and automatic 310 actions.

The hosted web site may then be updated 312 with the acquired advertisement content. In an alternative embodiment, the advertisement content may be stored 314, from which the site is then updated 316 with the received advertisement content and/or other stored content. In one embodiment, some subset of the stored advertisements may be chosen for the current presented advertisements via the mobile web site. In such an embodiment, when the next advertisement(s) is ready as determined at decision block 318, the site is updated 316 with the one or more stored advertisements available at that time. The advertisement(s) is then provided 320 or otherwise made available via the mobile web site.

The mobility of the user whose mobile device hosts the mobile web server allows different advertisements (and other content) to be gathered by the mobile device and ultimately hosted via the mobile web server. In one embodiment, gathering and disseminating such advertisements/content may provide a benefit for the person or entity to which the advertisement relates. As an example, if the user moves (physically or electronically) from store to store while gathering store ads, and includes such ads with the web content ordinarily associated with the user's mobile web site, the stores associated with the ads benefit by the mobile user's act of distributing their ads. In some cases, compensation 322 may be provided to the user who obtains and distributes advertisements and/or other content in this fashion. For example, the user of the hosting mobile device may receive a payment from an entity for downloading and thereafter hosting advertising content associated with that entity. The payment may be direct payment, store coupons, credit on a mobile device bill, frequent flyer miles or other similar “points,” and/or any other type of payment or benefit. This enables users of such hosting mobile devices to capitalize their web offering and bring value from their mobility and/or browsing actions.

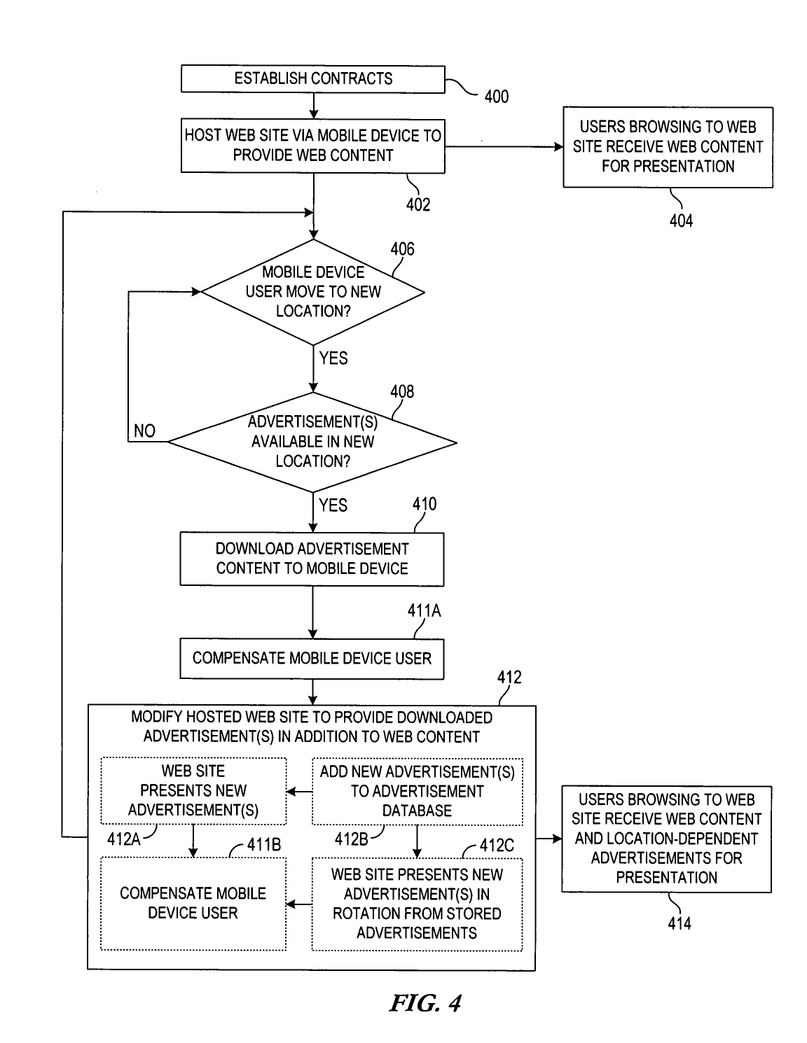

FIG. 4 illustrates an embodiment where some form of compensation may be provided to mobile users who obtain and distribute advertisements on behalf of other entities using the dynamic advertisement approach described herein. Contracts may be established 400 between the user hosting the mobile web service and the shops, businesses and other entities to which the advertisements pertain. These contracts may involve formal (e.g., legal) or informal agreements, and may be express or implied. Establishing contracts may be initiated manually, or may be initiated automatically such as upon identified dissemination of an advertisement for the respective entity. Such a contract is also entirely optional, and is not required in connection with the provision of dynamic advertisements of the invention.

In the illustrated embodiment, the web site is hosted 402 via the mobile device to provide web content that is normally associated with that user's mobile web service. Users can browse 404 to the web site to view, listen to and/or otherwise receive the hosted web content. When the mobile device user moves 406 to a new location, and if advertisements are available 408 at that new location, the advertisement content is downloaded 410 to the mobile device that hosts the mobile web service. Another condition to downloading the advertisement content may be, in some embodiments, that a contract has previously been established 400. In one embodiment, the downloading of advertisement content to the mobile device may trigger the compensation or other benefit to the mobile device user as depicted at block 411A. The compensation/benefit may be, for example, provided on an advertisement-by-advertisement basis and/or via the established contract(s) 400.

The hosted web site can be modified 412 to provide the downloaded advertisement(s) in addition to the web content that is normally provided via the web site. For example, the web site may simply present 412A the new advertisements, with or without providing other web content associated with the web site. In one representative embodiment the new advertisement(s) may be stored 412B in a database which is then consulted to identify the advertisement(s) to be presented 412A. One embodiment involves presenting 412C the new advertisements in rotation or other order from the stored advertisements. In any event, at least the location-dependent advertisements obtained at the various locations may then be viewed or otherwise presented 414 by users that browse to the mobile web site. In one embodiment, the presentation of the downloaded advertisement content via mobile device web server may trigger the compensation, additional compensation, or other benefit to the mobile device user as depicted at block 411B. Again, the compensation/benefit may be, for example, provided via any one or more of on an advertisement-by-advertisement basis, the length of presentation of advertisement, according to the established contract(s) 400, etc.

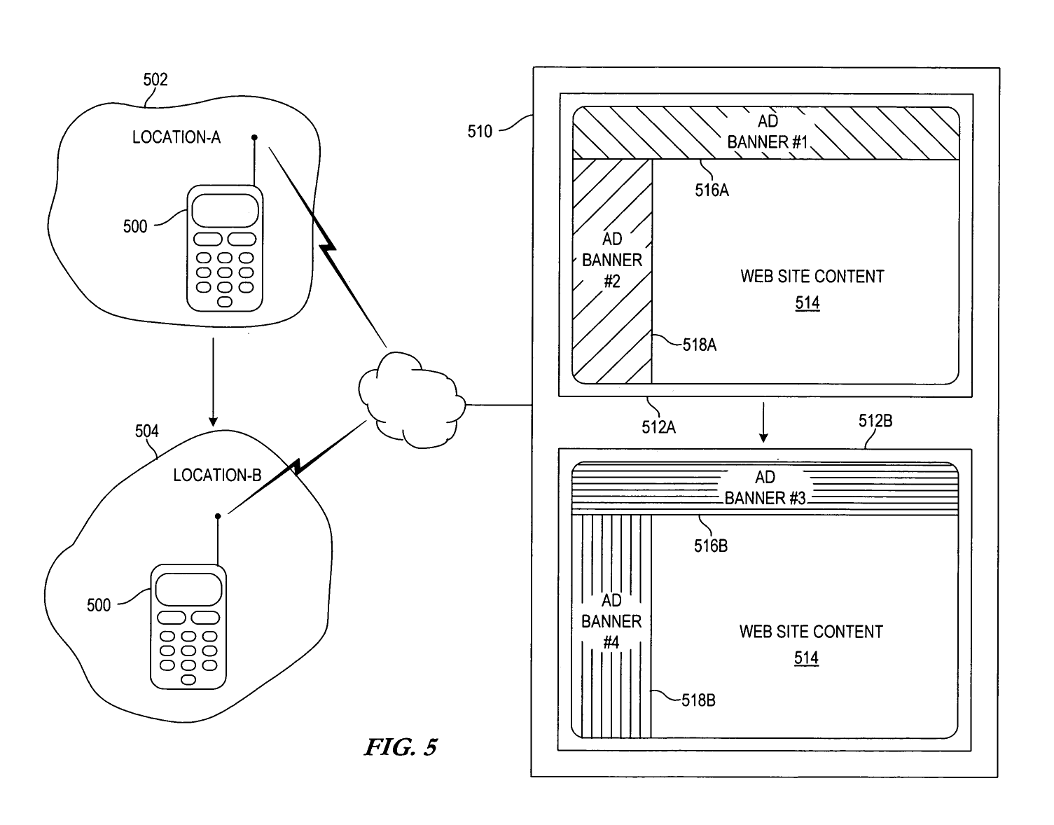

From the content consumer's point of view, he or she can receive the electronic or physical location-dependent information on his or her content access device. FIG. 5 illustrates a representative embodiment of the content consumer's presentation screen that can be viewed while browsing to or otherwise accessing the mobile web server and associated dynamic advertisements. While FIG. 5 illustrates an embodiment where the location-dependent information is in the form of advertisements, the content may differ from advertisements. Further, while the presentation to the content consumer is illustrated in the form of a visual presentation, the presentation is intended to include any type of presentation, including but not limited to visual, audio, tactile, etc.

In the embodiment of FIG. 5 it is assumed that the illustrated mobile device 500 includes a mobile web server as described herein. When at location-A 502, the mobile device 500 collects one or more location-dependent advertisements from an entity(s) (not shown). The mobile web server updates its content to include the downloaded or otherwise received advertisements, and hosts the mobile web site with the newly acquired advertisements. The depicted content consumer's device 510 includes a display screen 512A which presents the web site content 514 typically hosted by the mobile web server. In addition, the presentation includes the newly acquired advertisements, depicted as ad banner #1 516A and ad banner #2 518A. Thus, the advertisements acquired by the mobile web server of the mobile device 500 from an entity(s) at location-A 502 are ultimately provided to the content consumers as depicted by the dynamic banners 516A, 518A.

When the mobile device 500 is moved to another location-B 504, new advertisements may be available at that location-B 504. The mobile device 500 may again collect such location-dependent advertisements, but now from the entity(s) at location-B 504, whereby the mobile web server again updates its content to include these newly received advertisements. The content consumer's display screen 512B again presents the web site content 514, as well as the newly acquired advertisements depicted as ad banner #3 516B and ad banner #4 518B. Thus, the advertisements acquired by the mobile device 500 from the entity(s) at location-A 502 are ultimately provided to the content consumers as depicted by the dynamic banners 516B, 518B.

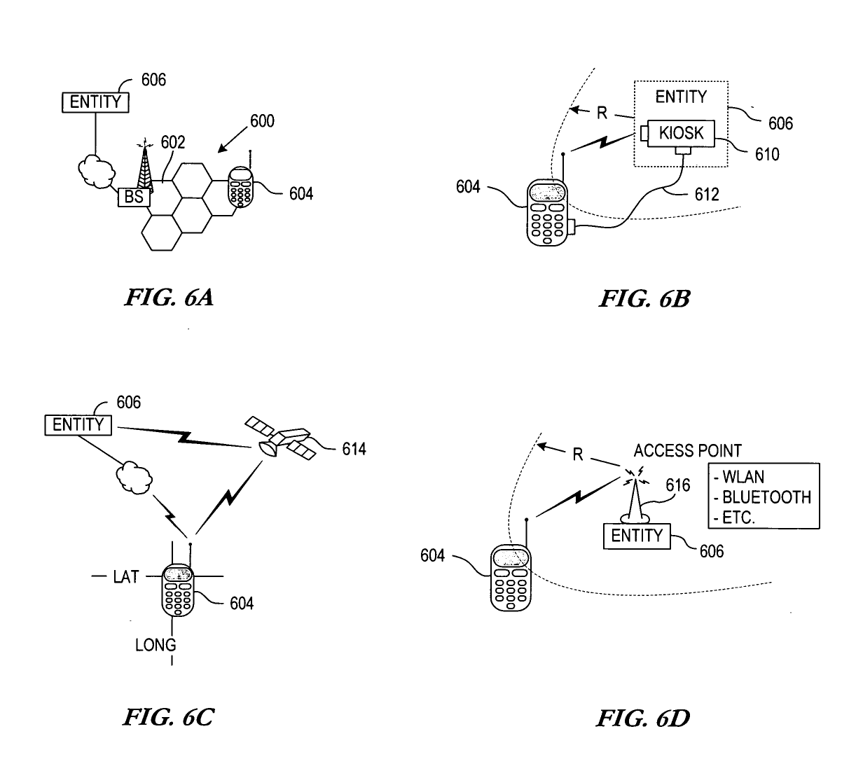

As previously indicated, the advertisement or other location-dependent content may be obtained by the mobile device and associated mobile web server in any known manner. FIGS. 6A-6D depict various representative embodiments in which such advertisement content may be received at the mobile web server. The embodiments identified in FIGS. 6A-6D do not, nor do they intend to, identify all manners in which the advertisement content may be received at the hosting mobile device. The depicted embodiments are provided for purpose of facilitating a representative understanding of how such information might be received at the hosting mobile device.

FIG. 6A illustrates an infrastructure-based network 600 involving divided regions or “cells” (e.g., cell 602), commonly referred to as a cellular network. As previously indicated, mobile devices 604 can be tracked to particular locations in the cellular network 600. For example, in a GSM network, individual cells within a particular location area are uniquely identified with a cell-ID. Together with the location area identifier, cells can be uniquely defined on an international level. Using such identifiers, cellular users can be tracked to various degrees of location specificity. Accordingly, the location of the mobile device 604 can be determined to varying degrees of specificity using any one or more of the identifiers associated with that mobile device 604 in the network 600. If the mobile device 604 is within any such identifiable area, entities 606 serving as sources of advertisements or similar content can initiate or request a transfer of the advertisements to the mobile web server associated with the mobile device 604. In this manner, the mobile device 604 can receive location-based advertisements, and include them with the web site content hosted by the respective mobile web server.

FIG. 6B illustrates an embodiment where the advertising source is represented by a kiosk 610 or other communications agent associated with one or more entities 606 that are to source an advertisement(s). The mobile device may communicate with a wireless range (R) of the kiosk 610 to wirelessly receive the advertising content. Any type of wireless communication protocol or technology may be utilized, such as WLAN, Bluetooth, Wibree, infrared, etc. For example, the user of the mobile device 604 may initiate communication with the kiosk 610 by initiating an infrared (IR) request to the kiosk, and the advertising content may be supplied to the mobile device using a wireless technology that is the same (e.g., IR) or different (e.g., GSM/GPRS). The advertising content may also be requested and/or received via a wired connection 612.

FIG. 6C illustrates another embodiment where Global Positioning System (GPS) technology is employed. The approximate latitude and longitude of a GPS-equipped mobile device 604 may be obtained with the use of a GPS satellite(s) 614. An entity 606 subscribing to a service to notify it of when the mobile device 604 is within its geographic area can be notified of the device's 604 location. In turn, the entity 606 can provide the advertising content to the mobile device 604 via, for example, GSM/GPRS or other data network.

FIG. 6D illustrates yet another embodiment by which the hosting mobile device can acquire the advertising content. This embodiment involves using a communications agent to assist in the transfer of advertising content to the hosting mobile device. For example, the communications agent may include a proximity network access point(s), whereby acquiring advertisement content may involve downloading the advertisement content associated with the entity by way of this proximity network access point. In the embodiment of FIG. 6D, the entity 606 may supply one or more such access points 616 to wirelessly communicate the advertising content to the mobile device 604 when the device 604 is within a communication range (R) of the particular access point 616. This embodiment involves any type of proximity network, such as WLAN, Bluetooth, Wibree, radio frequency (RF), etc. Peer-to-peer networking between the entity 606 and the device 604 may alternatively be utilized. As previously indicated, the embodiments of FIGS. 6A-6D are illustrated as examples of the various manners in which the hosting mobile device 604 may obtain the relevant advertising content, so that it may in turn provide such advertising content to users accessing its mobile web site.

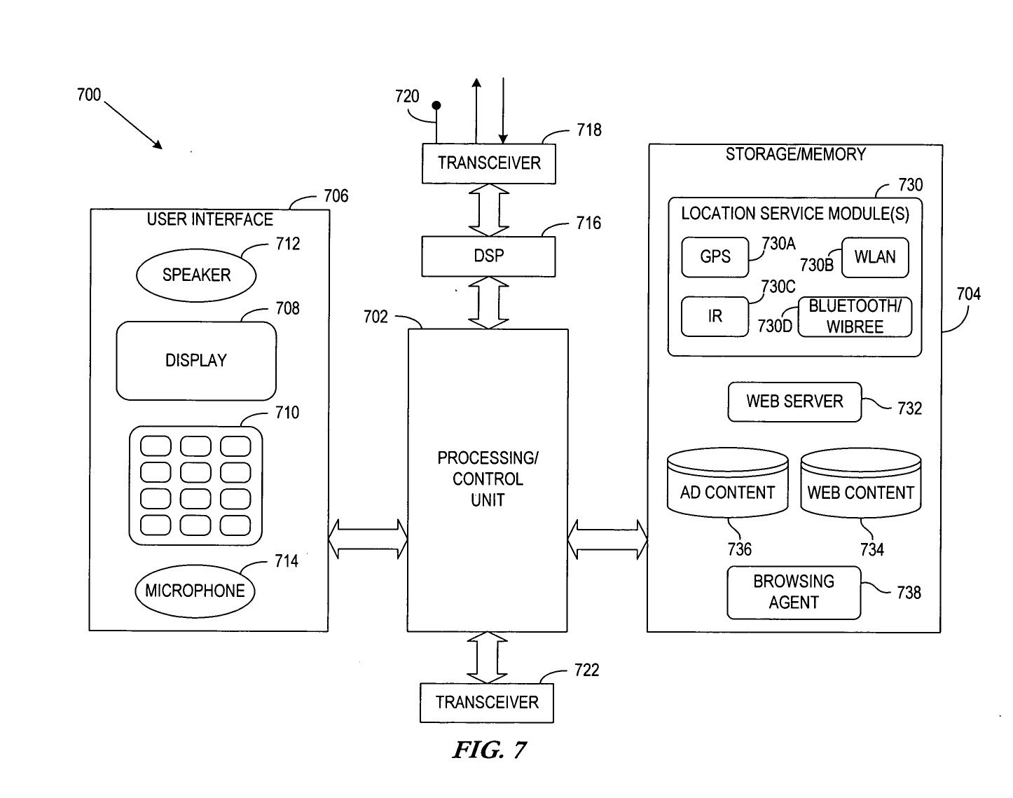

The mobile devices described in connection with the present invention may be represented by any number of wireless devices such as wireless/cellular telephones, personal digital assistants (PDAs), or other wireless handsets, as well as portable computing devices capable of wireless communication. The mobile devices utilize computing systems to control and manage the conventional device activity as well as the functionality provided by the present invention. Hardware, firmware, software or a combination thereof may be used to perform the various functions and operations described herein. An example of a representative mobile device computing system capable of carrying out operations in accordance with the invention is illustrated in FIG. 7.

The exemplary mobile computing arrangement 700 suitable for performing the dynamic banner activity in accordance with the present invention includes a processing/control unit 702, such as a microprocessor, reduced instruction set computer (RISC), or other central processing module. The processing unit 702 need not be a single device, and may include one or more processors. For example, the processing unit may include a master processor and one or more associated slave processors coupled to communicate with the master processor.

The processing unit 702 controls the basic functions of the mobile device as dictated by programs available in the program storage/memory 704. Thus, the processing unit 702 executes the functions associated with at least the gathering of advertising content and hosting the content via a mobile web server. More particularly, the program storage/memory 704 may include an operating system and program modules for carrying out functions and applications on the mobile device. For example, the program storage may include one or more of read-only memory (ROM), flash ROM, programmable and/or erasable ROM, random access memory (RAM), subscriber interface module (SIM), wireless interface module (WIM), smart card, disk, CD-ROM, DVD, or other resident or removable memory device. The agent(s) or other software operable with the processing unit 702 to perform functions in accordance with the invention may also be transmitted to the mobile computing arrangement 700 via data signals, such as being downloaded electronically via a network, such as the Internet.

The processor 702 is also coupled to user-interface 706 elements associated with the mobile device. The user-interface 706 of the mobile device may include, for example, a display 708 such as a liquid crystal display, a keypad 710, speaker 712, and microphone 714. These and other user-interface components are coupled to the processor 702 as is known in the art. The keypad 710 includes alpha-numeric keys for performing a variety of functions, including dialing numbers and executing operations assigned to one or more keys. Alternatively, other user-interface mechanisms may be employed, such as voice commands, switches, touch pad/screen, graphical user interface using a pointing device, trackball, joystick, and/or any other user interface mechanism.

The mobile computing arrangement 700 may also include a digital signal processor (DSP) 716. The DSP 716 may perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits and receives the radio signals associated with the wireless device. The computing arrangement 700 may also include a transceiver or other interface 722 to communicate data via wired technologies, such as USB, IEEE-1394, etc.

The program storage/memory 704 stores the various client programs and data used in connection with the present invention. The program storage/memory may include one or more location service modules 730 to enable the hosting mobile device to acquire the advertising content in accordance with the invention. Examples of such modules 730 include a GPS module 730A, WLAN module 730B, IR module 730C, Bluetooth, Wibree or similar module 730D, and/or the like. Such modules enable or otherwise facilitate identifying the location of the hosting mobile device in order to allow the hosting mobile device to acquire the location-dependent advertising content.

The storage/memory 704 also includes a web server 732, representing the software/firmware executable via the processing system 702 to manage content requests and facilitate delivery of the content to the requesting devices. An example includes a web server that accepts HyperText Transfer Protocol (HTTP) requests, where HTTP is the communication protocol presently used to convey information on the world wide web. More particularly, a requesting device may initiate a request for content via a client or agent program commonly referred to as a “browser,” which in turn creates the request in HTTP format and directed to the address (e.g., URL or other uniform resource identifier) of the web server 732. The web server 732 receives the request from the client/agent, and may provide the requested content in a format such as an HyperText Markup Language (HTML) format. However, the web server 732 of the present invention may utilize any communication protocols and document formats.

The illustrated program storage/memory 704 may also include a database or other storage of the web content 734 that includes HTML or other content that is normally associated with and ultimately provided via the web server 730. The storage/memory 704 may also optionally include an advertisement (ad) content database 736 to store advertising content acquired at the one or more locations visited by the hosting mobile device. In one embodiment of the invention, advertisement content 736 is stored in non-volatile electrically-erasable, programmable ROM (EEPROM), flash ROM, etc., so that the downloaded advertisements are not lost upon power down of the hosting mobile device. Further, the device 700 may include a browsing agent 738 or other similar software/firmware module, in order to access network sites to electronically acquire the advertising or other content.

These and other modules may be separate modules operable in connection with the processor 702, may be a single module performing each of these functions, or may include a plurality of such modules performing the various functions. In other words, while the modules are shown as multiple software/firmware modules, these modules may or may not reside in the same software/firmware program. It should also be recognized that one or more of these functions may be performed via hardware. These modules are representative of the types of functional and data modules that may be associated with a hosting mobile device in accordance with the invention, and are not intended to represent an exhaustive list. Also, other functions not specifically shown may be implemented by the processor 702.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile computing environments. For example, the programs and/or data may be stored in a variety of manners, may be operable on a variety of processing devices, and may be operable in mobile devices having additional, fewer, or different supporting circuitry and user-interface mechanisms.

Using the description provided herein, the invention may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “computer program product,” “modules,” and the like as used herein are intended to encompass a computing device-executable program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined in view of what would be apparent to those skilled in the art from the description provided herein and the claims appended hereto.

What is claimed is:

1. A method comprising:
acquiring advertisement content at a mobile device based on a context of the mobile device;
hosting a network-accessible server on the mobile device; and
providing at least the acquired advertisement content via the network-accessible server upon access to the network-accessible server by a requesting device.

2. The method of claim 1, wherein acquiring advertisement content based on a context of the mobile device comprises receiving the advertisement content based on a physical location of the mobile device relative to an entity that sources the advertisement content.

3. The method of claim 2, further comprising determining the physical location of the mobile device relative to the entity that sources the advertising content using a global positioning system.

4. The method of claim 1, wherein acquiring advertisement content based on a context of the mobile device comprises receiving the advertisement content based on a physical location of the mobile device relative to a communications agent of the entity associated with the advertisement content.

5. The method of claim 4, wherein the communications agent comprises a proximity network access point, and wherein acquiring the advertisement content comprises downloading the advertisement content associated with the entity via the proximity network access point.

6. The method of claim 4, wherein the communications agent comprises a kiosk, and wherein acquiring the advertisement content comprises downloading the advertisement content associated with the entity from the kiosk.

7. The method of claim 1, further comprising the mobile device moving from a first location to a second location, and wherein:
acquiring advertisement content at the mobile device comprises acquiring first advertisement content from a first location, and second advertisement content from a second location; and
providing at least the acquired advertisement content comprises providing at least the first advertisement content when the mobile device is at the first location, and providing the second advertisement content when the mobile device is at the second location.

8. The method of claim 1, further comprising the mobile device accessing a network site, and wherein acquiring advertisement content based on a context of the mobile device comprises receiving the advertisement content at the mobile device as a result of the accessing of the network site.

9. The method of claim 1, further comprising the mobile device browsing to an external web site to access first content, and wherein acquiring advertisement content based on a context of the mobile device comprises automatically receiving the advertisement content at the mobile device as a result of browsing for the first content.

10. The method of claim 1, wherein hosting a network-accessible server includes configuring one or more web pages to present to the requesting device a display area corresponding to first web content associated with network-accessible server, and to present to the requesting device at least one additional display area corresponding to the advertisement content.

11. The method of claim 1, further comprising establishing an agreement between the user of the hosting mobile device and an entity that sources the advertisement content, and wherein acquiring and providing the advertisement content via the network-accessible site on the mobile device is dependent on the prior establishment of the agreement.

12. The method of claim 1, further comprising hosting web content via the network-accessible server, and wherein providing at least the received advertisement content comprises providing both the web content and the received advertisement content to the requesting device via the network-accessible server.

13. An apparatus comprising:
a location services module configured to facilitate determination of a location of the apparatus relative to an entity;
a receiver configured to receive advertisement content when the determined location of the apparatus relative to the entity enables receipt of the advertising content from the entity; and
a mobile web server module configured to update web content with at least some of the advertisement content, and to provide the updated web content to requesting devices in response to their access to the mobile web server module.

14. The apparatus as in claim 13, further comprising a browsing agent configured to access one or more network sites, wherein the receiver receives at least some of the advertisement content as a result of the browsing agent accessing the respective one or more network sites.

15. The apparatus as in claim 13, further comprising a browsing agent configured to access an external web site to access first content, wherein the receiver receives at least some of the advertisement content as a result of the browsing agent accessing the first content at the external web site.

16. The apparatus as in claim 13, wherein the receiver is configured to acquire first advertising content when the location services module determines that the apparatus is located at a first location, and to acquire second advertising content when the location services module determines that the apparatus is located at a second location.

17. The apparatus as in claim 16, further comprising a database configured to store the advertising content received from at least the first and second locations, and wherein the mobile web server module is configured to update web content with at least the first and second advertising content irrespective of the location of the apparatus when the updated web content is provided to the requesting devices.

18. The apparatus as in claim 13, wherein the mobile web server is configured to provide the updated content to the requesting devices at a time when the apparatus is located at the location where the advertisement content was received.

19. A system comprising:
an entity having a communications agent associated therewith to facilitate communication of advertisement content; and
a mobile device comprising:
a location services module configured to facilitate determination of a location of the apparatus relative to the entity;
a receiver configured to receive the advertisement content via the communications agent when the determined location of the mobile device is within a communication range of the communications agent; and
a mobile web server configured to update web content with at least some of the received advertisement content, and to make the updated web content available to requesting devices in response to their access to the mobile web server.

20. The system of claim 19, further comprising at least one requesting device capable of initiating a request for the updated web content via a network, wherein the requesting device includes a display module configured to present the updated web content to distinguish the received advertisement content from other web content hosted by the mobile web server.

21. The system of claim 19, wherein the entity having the communications agent comprises a proximity network access point capable of wirelessly communicating the advertisement content to the receiver of the mobile device.

22. The system of claim 19, wherein the entity having the communications agent comprises a kiosk capable of storing the advertisement content and providing the advertisement content to the receiver of the mobile device.

23. The system of claim 19, wherein the mobile device further comprises a browsing agent configured to access one or more network sites, wherein the receiver is configured to receive at least some of the advertisement content as a result of the browsing agent accessing the respective one or more network sites.

24. Computer-readable media having instructions stored thereon which are executable by a processing system for performing steps comprising:
acquiring advertisement content at a device based on a context of the mobile device;
hosting a network-accessible server on the device; and
providing at least the acquired advertisement content via the network-accessible server upon access to the network-accessible server by a requesting device.
